(19) United States
(12) Patent Application Publication
(10) Pub. No.: US 2019/0112158 A1
(43) Pub. Date: Apr. 18, 2019

(54) ELEVATOR ARRANGEMENT AND ELEVATOR

(71) Applicant: Kone Corporation, Helsinki (FI)

(72) Inventors: Markku HAAPANIEMI, Helsinki (FI); Ari Katttainen, Helsinki (FI); Janne Mikkonen, Helsinki (FI); Matti Rasanen, Helsinki (FI); Esko Aulanko, Kerava (FI)

(73) Assignee: Kone Corporation, Helsinki (FI)

(21) Appl. No.: 16/221,711

(22) Filed: Dec. 17, 2018

Related U.S. Application Data
(63) Continuation of application No. PCT/FI2016/050523, filed on Jul. 15, 2016.

(51) Int. Cl. B66B 11/02; B66B 5/00

(52) U.S. Cl. CPC B66B 11/0246; B66B 5/0087; B66B 5/005

(57) ABSTRACT

The invention relates to an elevator arrangement comprising an elevator with an elevator control system, a safety system and an inspection or maintenance mode, which elevator having an elevator car arranged to run up and down in an elevator shaft along guide rails, and which elevator car is equipped with a roof. The roof of the elevator car is arranged to uncover upper part of the elevator car in order to form a natural safe working space inside the elevator car, and that the arrangement comprises a control mechanism in order to control the position of the roof.

This application is a continuation of PCT International Application No. PCT/FI2016/050523 which has an International filing date of Jul. 15, 2016, the entire contents of which are incorporated herein by reference.

The present invention relates to an elevator arrangement as defined in the preamble of claim 1 and to an elevator as defined in the preamble of claim 16.

This invention relates particularly to an elevator where a headroom is low. The headroom in this context means the clearance between the roof of the elevator car and the ceiling of the elevator shaft in the situation when the elevator car is at its uppermost position. In an advantageous solution the headroom can be so low that the height of the elevator shaft is equal to the height of the floors of the building. In that case the elevator shaft can be totally inside the building.

Many kinds of tasks, such as tests, inspections, adjustment works, maintenance or repairs, later referred in a shorter way only as “maintenance work”, are often performed at the upper part of the elevator shaft. In that case the safety of the persons performing the tasks mentioned above has always to be secured. If the height of the top clearance of the elevator shaft is low, in other words the headroom is low, a sufficient safety space, which prevents injuries occurring for persons working on the roof of the elevator car, cannot always be guaranteed without special procedures.

Standards such as EN81 require certain minimum safety distances between elevator car and the top and the bottom of the elevator shaft to provide a person a safe working space when he/she is accessing to the machines and shaft components. A safety space is a natural one if suitable clearance is available without shortening the stroke of the elevator car. In some cases natural safe working spaces are not possible to provide, because the elevator shaft is not tall enough and thus there is no room in the elevator shaft above the topmost position of the elevator car and/or below the lowest position of the elevator car. In such cases artificial safety spaces can be created. The artificial safety space creation requires additional equipment, such as brakes or movable buffers, and particular safety considerations.

Usually the maintenance work is done on the roof of the elevator car. In that case, when working on the roof of the elevator car an unintentional movement of the elevator car must be prevented in some other way than by the regular operating brakes of the elevator. It is known in the prior art that this kind of prevention can be done by locking the elevator car and/or the counterweight into their positions on the guide rail, for instance by means of a safety gear, a latch or wedges. However, this often requires that the working persons must separately go to the elevator shaft and perform the locking. That makes safety preparation tasks awkward, laborious and time-consuming.

Another solution according to prior art for achieving an adequate safety space in the upper part of an elevator shaft is to use one or more turnable buffers that are disposed below the counterweight. The buffer is lifted upright before going onto the roof of the elevator car. The length of the buffer is such that the movement of the counterweight, and at the same time the movement of the elevator car, stops before the elevator car rises too high with respect to the ceiling of the elevator shaft. One problem, among others, in this solution is, however, that the shaft space might have been dimensioned so precisely that there is no proper space in the bottom part of the elevator shaft for a turnable buffer. Another problem is that the aforementioned buffer ensuring the top safety space is in the bottom part of the elevator shaft, i.e. right at the other end of the elevator shaft. In that case installing the buffer into the safe position takes extra time and it may also happen that for this reason the person in charge does not remember to go down to the bottom of the elevator shaft to turn them into the safe position.

In addition to the aforementioned, the safety solutions are often based on electrical supervision controls installed in the doors of the shaft, which controls must be switched to the safe position before going onto the roof of the elevator car. Turning the buffers into the safe position and activation of the electrical control circuits are often such a complex combination that, particularly e.g. with small tasks, they might be left undone owing to their complexity and for saving the time used. In addition, electrical supervision control systems could be susceptible to failure.

Yet one solution according to the prior art is shown in the US patent publication No. US2010/0200339 A1. The solution according to the US publication presents an elevator safety system for elevators with a reduced upper end of the elevator shaft. In this solution the roof of the elevator car cannot be used as a working base, because the roof of the elevator car is constructed so that it does not support weight. Thus, it is not possible to be or work on the roof of the elevator car. In this case the required free safety space is formed completely inside the elevator car when the elevator car is in its uppermost position. As the roof is not designed to bear loads, in such a situation a weight on the roof may deform or even broke the roof structures. The maintenance work at the top part of the elevator shaft is done inside the elevator car. For this purpose a part of the sidewall of the car is made removable and the maintenance work is done though the opening in the sidewall when the part mentioned above has been removed from the sidewall. However, the problem in this solution is the fact that there are only limited possibilities to make inspection, repair and maintenance work because only one certain opening is used. And likewise there are limited possibilities to place elevator appliances that require regular maintenance in the elevator shaft because the opening is only at one sidewall of the car. In addition the opening makes the wall structure more expensive, more complicated and also weaker than the unbroken wall structure.

When making maintenance work the elevator is set to the maintenance mode which prevents the normal use of the elevator and, for instance, calling the elevator car from landing floors. Also landing doors cannot be open and an access to the elevator shaft is prevented. However, in that case landing doors can be opened by a special key, for instance with a so-called triangle key. This brings out a new problem because those special keys are easily available. In that case unauthorized persons can acquire that kind of special key and open the landing doors of the elevator shafts for their own purposes. This increases risks of accidents. Another problem is that mechanic solutions to open the landing doors increase the costs of the elevator and also cause visual problems in the door area of elevators because additional holes must be done into doors in every floor.

One objective of the present invention is to eliminate drawbacks of prior art technology and to achieve an elevator arrangement where the headroom at the upper part of the elevator shaft can be as low as possible, and the elevator shaft is completely inside the building so that there is no need to penetrate the roof of the building. Another objective of the present invention is to create a safe working space inside the elevator car for maintenance work of the elevator appliances in the elevator shaft and the top part of the elevator car. Yet another objective of the present invention is to achieve a control mechanism to control the position of roof of the elevator car and also if weight greater than the predefined weight is aimed onto the roof of the elevator car. And yet another objective of the present invention is to achieve a safety arrangement that is operationally extremely reliable, easy and fast to use, and that immediately prevents the movement of the elevator car if somebody steps onto the roof of the elevator car. Yet another objective of the present invention is to achieve an elevator arrangement where there is no need to open landing doors for doing maintenance work of the elevator appliances in the elevator shaft.

The elevator arrangement according to the invention is characterized by what is disclosed in the characterization part of claim 1. Other embodiments of the invention are characterized by what is disclosed in the other claims.

A preferred aspect of the elevator arrangement and the elevator of the invention is enabling the movement of the elevator car only when the roof of the car is fully opened or fully closed. In fully closed and in fully opened positions the roof can be easily locked to its position and it is also easy to monitor, that the roof holds its locked position.

The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can, in at least some situations, be deemed to be inventive in their own right.

In order to achieve the objectives of the present invention the roof of the elevator car is opened for creating a safe working space inside the elevator car for maintenance work and for enabling the elevator shaft maintenance work and also maintenance of equipment located adjacent to the elevator car top. And in order to sufficient safety the position of the movable roof is electrically controlled.

In order to achieve the objectives mentioned above, the present invention provides an elevator arrangement comprising an elevator with an elevator a control system, a safety system and an inspection or maintenance mode, which elevator having an elevator car arranged to run up and down in an elevator shaft along guide rails, and which elevator car is equipped with a roof. Advantageously the roof of the elevator car is arranged to uncover upper part of the elevator car to form a natural safe working space for conducting inspection and maintenance tasks from inside the elevator car to the elevator shaft and to form the refuge space inside the elevator car, and that the arrangement comprises a control mechanism in order to control the position of the roof.

Advantageously the control mechanism comprises at least a trigger element and control switches activated by the movement of the trigger element and operatively connected at least to the elevator control system and to the elevator safety system. Further, the trigger element is arranged to move in connection with the movement of the roof of the elevator car.

One advantage of the invention is that the invention enables maintenance work for the appliances at the top part of the elevator shaft without the need to step onto the roof of the elevator car. Thus, all the maintenance work can be done from inside the elevator car. Another advantage of the solution according to the invention is that a safe working space for elevator maintenance work is created inside the elevator car. Yet another advantage of the solution according to the invention is that a movement of the elevator car can be effectively, reliably and safely prevented if somebody steps onto the roof of the elevator car or there is more weight than a predetermined value allows on the roof of the elevator car.

One further advantage of the invention is that the invention enables a safe way of providing an elevator that has an extremely low top clearance or headroom. The top clearance can even be minimized to the minimum, or close to the minimum, required only by the trajectory of the elevator car. Thus when the elevator car is in its uppermost possible position on its trajectory, the shaft space above the elevator car is small and the height of the elevator shaft can easily be fitted inside the building, without penetrating the roof of the building.

Yet another advantage is that the solution is very easy and quick to use, and does require neither awkward working in the elevator shaft nor preliminary procedures at the top end or bottom end of the elevator shaft. Yet a further advantage is also that the solution is inexpensive and simple to implement. Yet a further advantage is that uplifted roof of the elevator car protects the working person in the elevator car from possible falling objects in the elevator shaft.

Yet another advantage of the solution according to the invention is that the number of control switches for safety functions can be reduced to minimum.

Yet another advantage of the solution according to the invention is that there is no need to open the landing doors for maintenance purposes and therefore the special key to open the landing doors are not needed. That also effectively prevents an authorized access onto the roof of the elevator car.

Also there is no need to make holes in the door leaves for the special keys, and no need to arrange complex special opening mechanisms in door structures. That makes the outward appearance of the landing doors look better and prevents unauthorized persons to open the landing doors with special keys they have copied or acquired without authorizing license.

In the following, the invention will be described in detail by the aid of example embodiments by referring to the attached simplified and diagrammatic drawings, wherein

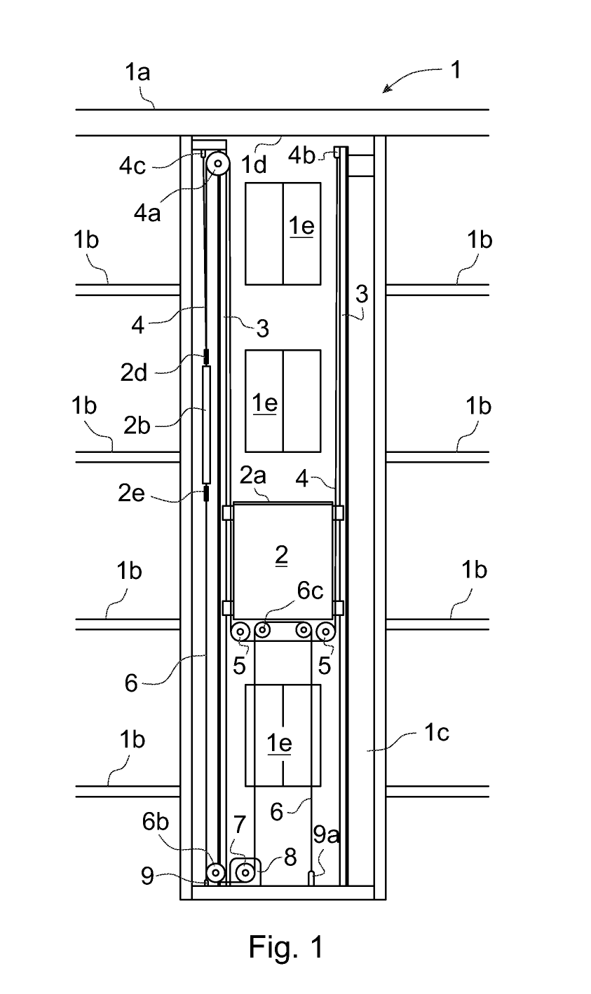

FIG. 1 presents in a simplified and diagrammatic back view a part of the building where the back wall of the elevator shaft is removed, and an elevator in the elevator shaft, in which elevator the solution according to the invention can be used,

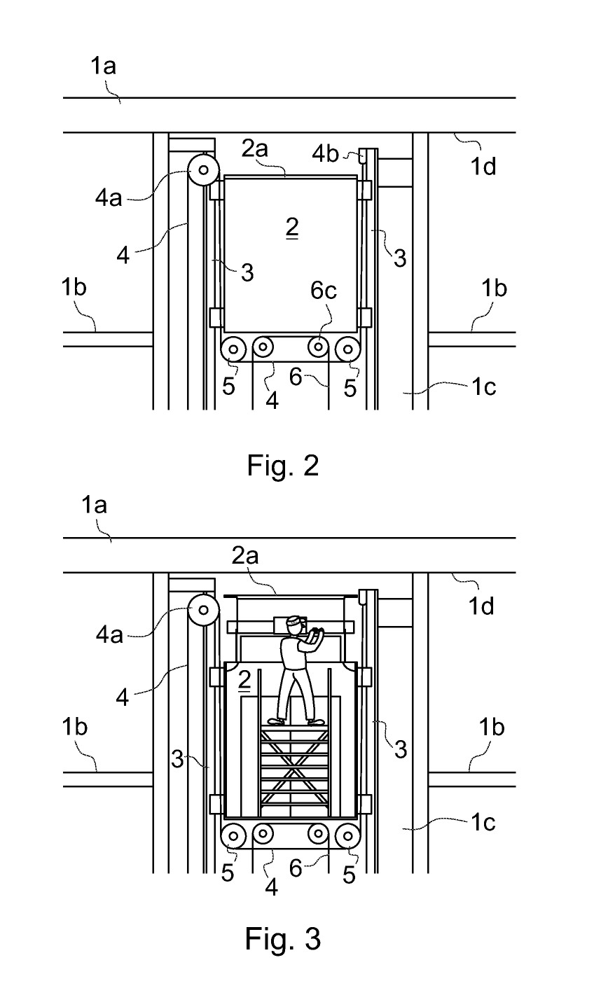

FIG. 2 presents in a simplified and diagrammatic back view the upper part of the elevator shaft in the building according to FIG. 1,

FIG. 3 presents in a simplified and diagrammatic back view the upper part of the elevator shaft in the building according to FIG. 1 in the situation where the maintenance or repair task is in progress,

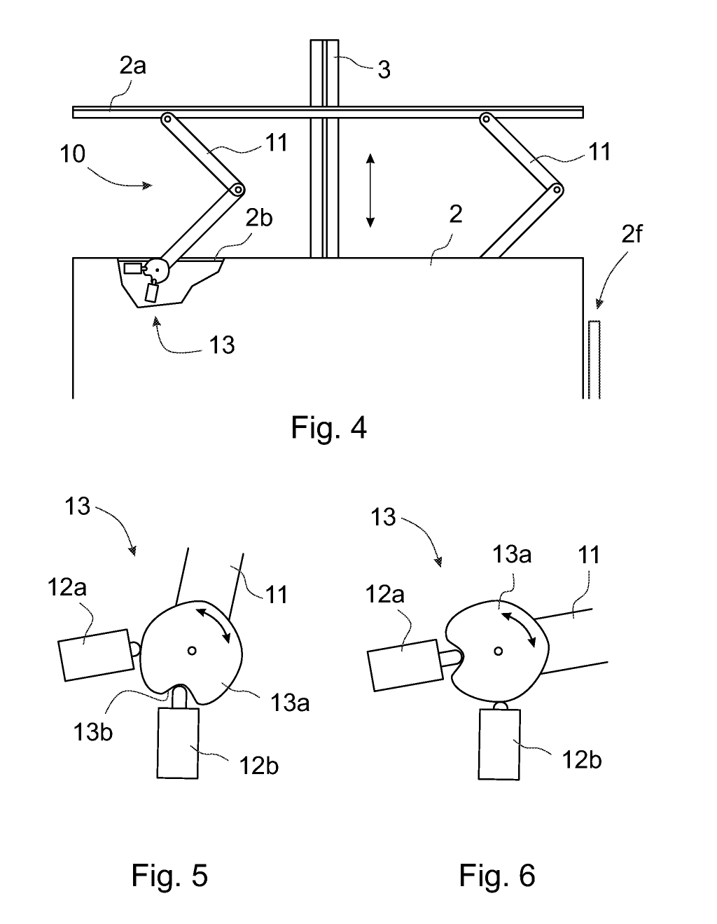

FIG. 4 presents in a simplified and diagrammatic side view an upper part of the elevator car according to the invention in a situation where the roof of the elevator car is opening for instance for maintenance work,

FIG. 5 presents in a simplified and diagrammatic and an enlarged side view a part of the electrical control mechanism according to the invention in order to control the position of the roof of the elevator car, in the situation where the roof is in its uppermost position,

FIG. 6 presents in a simplified and diagrammatic and an enlarged side view a part of the electrical control mechanism according to the invention in order to control the position of the roof of the elevator car, in the situation where the roof is in its lowermost position,

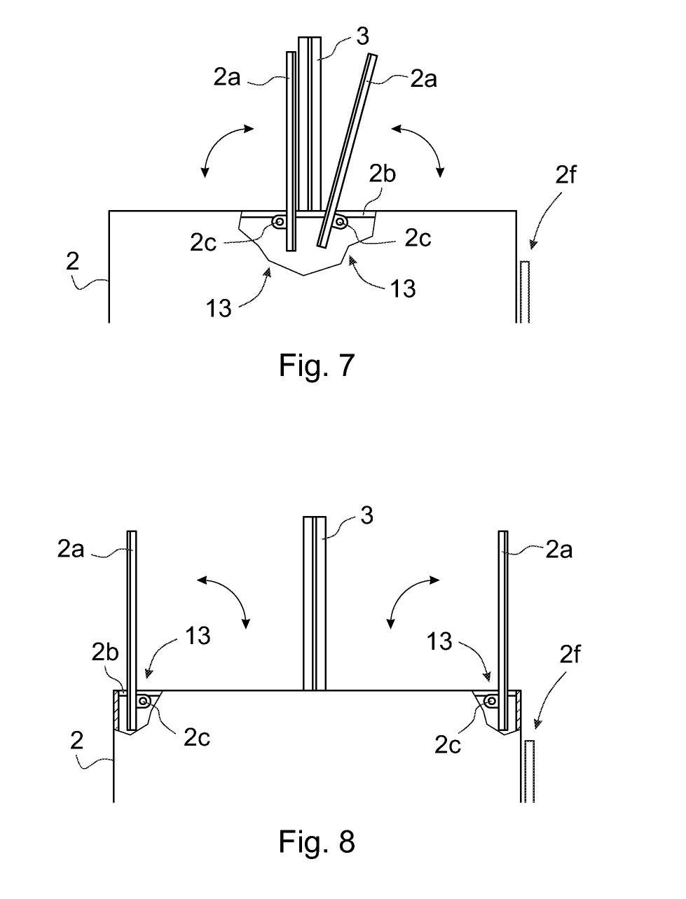

FIG. 7 presents in a simplified and diagrammatic side view an upper part of the elevator car according to another embodiment of the invention when the roof is partially open for maintenance work, and

FIG. 8 presents in a simplified and diagrammatic side view an upper part of the elevator car according to yet another embodiment of the invention when the roof is open for maintenance work.

An aspect of the invention is to achieve an elevator arrangement with an elevator car having an easily openable and controllable roof which makes it possible to access maintenance and repair targets in an elevator shaft and in the outer upper part of the elevator car from inside the elevator car, and which also removes the need to step onto the roof of the elevator car, and in addition to that, also reduces the height of the shaft needed.

FIG. 1 presents in a simplified and diagrammatic back view a part of the building 1 where the back wall of the elevator shaft 1c is removed, and an elevator in the elevator shaft 1c, in which elevator the solution according to the invention can be used. The building 1 has a roof 1a just above the elevator shaft 1c and four floors 1b served by the elevator.

The elevator comprises among other things an elevator car 2 with an openable roof 2a, which elevator car 2 is arranged to run up and down in the elevator shaft 1c along guide rails 3, and a counterweight or balance weight 2b that is also arranged to run up and down in the elevator shaft 1c along its guide rails which are not presented in FIG. 1 for the sake of clarity. Later in this connection only balance weight 2b is mentioned when either counterweight or balance weight is meant.

Advantageously the supporting and moving of the elevator car 2 are separated from each other. This makes it possible to achieve an elevator structure where the height of the headroom above the elevator car 2 can be as low as possible. The elevator car 2 is driven by a hoisting machinery 8 equipped with a drive wheel 7. Advantageously the hoisting machinery 8 is located at the bottom part of the elevator shaft 1c, below the elevator car 2 and advantageously below the first floor level 1b.

A traction member 6 is connected between the balance weight 2b and the elevator car 2. The traction member 6 can be a single member or a bunch of similar parallel members, for instance, the traction member 6 can be a toothed belt, chain or other type of member that does not slip on the drive wheel 7. In this embodiment the suspension ratio of the traction member 6 is 2:1. In that case the first end of the traction member 6 is secured at its first fastening point 9, for example at the bottom part of the elevator shaft 1c. From the first fastening point 9 the traction member 6 is led upwards to go over and around a traction sheave 2e in connection with the balance weight 2b and from the traction sheave 2e the traction member 6 is led downwards to go under and around a diverting pulley 6b and the drive wheel 7 of the hoisting machinery 8 at the bottom part of the elevator shaft 1c, from where the traction member 6 continues upwards to go over and around diverting pulleys 6c at the bottom of the elevator car 2 and from the diverting pulleys 6c again downwards to its second fastening point 9a where the second end of the traction member 6 is secured, for example at the bottom part of the elevator shaft 1c.

The elevator car 2 is suspended by suspension element 4 that is connected between the balance weight 2b and the elevator car 2. The suspension element 4 can be a single member or a bunch of similar parallel members, for instance suspension ropes. In this embodiment the suspension ratio of the suspension element 4 is 2:1. In that case the first ends of the suspension element 4 are secured at their first fastening point 4c, for example at the top part of the guide rail 3, from which the suspension element 4 is led downwards to go under and around a diverting pulley 2d in connection with the balance weight 2b. From the diverting pulley 2d the suspension element 4 is led upwards to go over and around a diverting pulley 4a that is fitted with bearings on its shaft, for instance at the upper part of the guide rail 3. From the diverting pulley 4a the suspension element 4 descends downwards to go under and around diverting pulleys 5 at the bottom of the elevator car 2 and from the diverting pulleys 5 the suspension element 4 is led upwards to its second fastening point 4b where the second end of the suspension element 4 is secured, for example at the top part of the guide rail 3. The elevator car 2 is also equipped with safety gear system that is arranged to stop the movement of the elevator car 2 and to lock the elevator car 2 into the guide rails 2 when needed. Thanks to the suspension like this the roof 2a of the elevator car 2 can be openable, which means that greatest part of the upper part of the elevator car (2) can be uncovered in order to expose a manhole for performing maintenance, test, inspection and/or repair works, etc. in the elevator shaft 1c and at top part of the elevator car 2.

Each floor has a landing door 1e that is presented in FIG. 1 seen from the direction of the elevator shaft 1c. In addition the elevator comprises at least an operating system, a control system, an electrical system, a variety of sensor arrangements and a safety system comprising an inspection mode, which inspection mode is here a common term for the operation mode which is activated when performing inspection, test, maintenance or repair work or other operations that require a safe working environment.

FIG. 2 presents in a simplified and diagrammatic back view the upper part of the elevator shaft 1c in the building 1 according to FIG. 1. Also in this figure the back wall of the elevator shaft 1c is removed and the elevator shaft 1c is seen from its backside. In the situation of FIG. 2 the elevator car 2 is in its uppermost floor 1b in the top part of the elevator shaft 1c. The top clearance between the roof 2a of the elevator car 2 and the ceiling 1d of the elevator shaft 1c is at its minimum. In that solution the height of the elevator shaft 1c is equal to the total height of the floors 1b of the building 1 or even less than the total height of the floors 1b of the building 1. In that case the elevator shaft 1c can be totally inside the building 1.

FIG. 3 presents in a simplified and diagrammatic back view the upper part of the elevator shaft 1c in the building 1 according to FIG. 1 in the situation where the maintenance or repair task, etc. is in progress. The openable roof 2a of the elevator car 2 is opened, in this embodiment by lifting it upwards, and a maintenance hole or opening is created between the uplifted roof 2a and the upper edges of the elevator car 2. The elevator car 2 has been run with a service run or inspection run in an appropriate location in the elevator shaft 1c so that the working person being inside the elevator car 2 has an easy access to the elevator components and appliances in the elevator shaft. In this case the required safety space is created at least partly inside the elevator car 2. In case the maintenance work is done lower in the elevator shaft 1c, the uplifted roof 2a protects the working person also from falling tools and other objects that may fall down into the elevator shaft 1c from other working sites above, for instance from a top part of a neighboring elevator shaft where another elevator is installed at the same time.

FIG. 4 presents in a simplified and diagrammatic view, an upper part of the elevator car 2 according to the invention. In FIG. 4 the roof 2a is partially open for a maintenance or repair work and supported by articulated arms 11 with lower, middle and upper pivot points. Partially open here means that the roof 2a is lifted upwards but it is not yet in its uppermost position. An uncovered manhole or opening 2b on top of the elevator car 2 makes it possible to reach the elevator appliances or components in the elevator shaft 1c from inside the elevator car 2 when the roof 2a is fully open, i.e. in its uppermost position. The vertical position of the roof 2a is controlled with an electrical control mechanism 13 that is installed at the lower part of at least one of the articulated arms 11 supporting the roof 2a.

In the embodiment of FIG. 4 the roof 2a is openable by lifting it straight upwards. For that purpose the elevator comprises opening means 10 that are arranged to open and close the roof 2a when the elevator is switched on to a safe inspection or maintenance mode, later in a shorter way referred only as “inspection mode”. The moving of the roof 2a can be carried out in several ways. One way is to use the articulated arms 11 mentioned above and one or more actuators to turn the articulated arms 11. In this embodiment four articulated arms 11 are used, two pieces on each side of the elevator car 2. The articulated arms 11 help to lift and lower the roof 2a. The actuators to lift and lower the roof 2a are not presented in FIG. 4, but they can be, for instance, gas springs, screws driven by a crank or electric motor, springs associated with dampening gas springs, or the roof 2a can be even moved manually by pushing the roof 2a upwards and pulling it downwards. When lifting and lowering the roof 2a manually gas springs can be used to ease the lifting and to dampen the movement of the roof 2a when closing it so that the roof 2a does not unwantedly hit the upper edges of the elevator car 2.

FIGS. 5 and 6 present in a simplified, diagrammatic and an enlarged side view a part of the electrical control mechanism 13 according to the invention in order to control the position of the roof 2a of the elevator car 2. FIG. 5 presents the situation where the roof 2a is in its uppermost position, and FIG. 6 presents the situation where the roof 2a is in its lowermost position. The electrical control mechanism 13 comprises a trigger element 13a and at least two electrical control switches, a normal closed switch 12a or the first switch and a normal open switch 12b or the second switch, which switches 12a, 12b are operatively connected at least to the elevator control system and the elevator safety system. The trigger element 13a is, for example, a roundish disc that has convex outer edges on both sides of a concave recess 13b in the periphery of the disc. The trigger element 13a is fastened to the lower pivot point of at least one articulated arm 11 at the lower end of said articulated arm 11. So, the disc of the trigger element 13a turns or rotates along the lower part of the articulated arm 11 and at the same time the trigger element 13a rotates around its pivot point.

The control switches 12a, 12b are placed so that when the roof 2a is in its lowermost position the trigger of the normal closed switch 12a is in the recess 13b of the trigger element 13a. In that case the elevator control system has received a signal that the elevator is in a normal mode and that the elevator can be run in a normal mode.

When lifting the roof 2a the articulated arm 11 rotates around its lowermost pivot point and at the same time the trigger element 13a rotates around its pivot point. At that time the trigger element 13a changes the state of the normal closed switch 12a by pushing the trigger the normal closed switch 12a inwards, and as a result the power circuit that enables inspection mode opens. In that case the elevator control system receives a signal that the elevator is not any more in a normal mode and the elevator comes to a halt if the roof 2a has been tried to lift during a normal run of the elevator. If the elevator car 2 was not in motion the elevator cannot start running as long as the roof 2a is not in its uppermost position.

When the roof 2a has been lifted to its uppermost position the trigger of the normal open switch 12b hits the recess 13b, the power circuit that enables inspection mode closes and the normal open switch 12b sends the elevator control system a signal that the inspection mode is allowed. In that case the inspection run is allowed.

In case, when the roof 2a is in its lowermost position and the elevator is in the normal mode, somebody steps onto the roof 2a of the elevator car 2 the weight of the person presses the roof 2a downwards, the trigger element 13a rotates and the trigger of the normal closed switch 12a comes out from the recess 13b in which case the elevator control system receives a signal that the elevator is not any more in the normal mode. In that case neither the normal mode run nor the inspection run is allowed.

In an advantageous embodiment of the invention the electrical control mechanism 13 with its trigger element 13a and control switches 12a, 12b is also arranged to activate the safety gear of the elevator. In that case the safety gear comprises a solenoid that is controlled by the control switches 12a, 12b. When the control mechanism 13 triggers the solenoid it activates the safety gear in which case the movement of the elevator car 2 comes to its halt after a certain predetermined travel if the elevator car 2 starts to move. When the roof 2a reaches its uppermost position the normal open switch 12b is activated and the inspection run becomes allowed in the inspection mode.

The same control switches 12a, 12b can be arranged to control the lighting during the inspection run. In that case the lamps for the lighting are placed, for instance onto the roof 2a of the elevator car 2 or in the edges of the up moving roof 2a. In that case the lighting needs no additional switches.

FIG. 7 presents in a simplified and diagrammatic side view an upper part of the elevator car 2 according to another embodiment of the invention when the roof 2a is open for maintenance or repair work and the position of the roof 2a is controlled by the electrical control mechanism 13. In this embodiment the roof 2a consists of two halves that are hinged with a hinge 2c at their first ends at the upper part of the sidewalls of the elevator car 2 in the middle area of the elevator car 2. Thus the halves of the roof 2a are closing towards the front edge and back edge of the elevator car 2 and opening towards the center of the elevator car 2. This gives more space for maintenance work in the backside of the elevator car 2 and in the front side of the elevator car 2 where, for example the door machinery is. An advantageous place for the trigger 13a of the electrical control mechanism 13 is in connection with the hinge 2c.

FIG. 8 presents in a simplified and diagrammatic side view an upper part of the elevator car 2 according to yet another embodiment of the invention when the roof 2a is open for maintenance or repair work and the position of the roof 2a is controlled by the electrical control mechanism 13. In this embodiment the roof 2a also consists of two halves that are hinged with a hinge 2c at their first ends at the upper part of the sidewalls of the elevator car 2. In this case the hinge points are close the front wall and back wall of the elevator car 2. In this case the halves of the roof 2a are closing towards the center of the elevator car 2 and opening towards the front edge and back edge of the elevator car 2. This gives more space for maintenance work in the sides of the elevator car 2 where, for example the guide rails are. An advantageous place for the trigger 13a of the electrical control mechanism 13 is in connection with the hinge 2c.

According to the invention the elevator car 2 has roof 2a that can be lifted upwards to create an access for maintenance purposes to the elevator appliances in the elevator shaft 1c and to elevator components at the upper part of the elevator car 2. The person performing maintenance tasks can stand in a good position on a special portable working surface that is placed inside the elevator car 2, and has an access to all the components that need maintenance. During the maintenance tasks the interior of the elevator car 2 is in this case a natural safe working space according to the elevator regulations. In addition the uppermost position of the uplifted roof 2a is arranged so that the cap between the roof 2a and the upper edges of the elevator car 2 is so small that the maintenance person cannot climb out from the elevator car 2 into the elevator shaft 1c and step onto the roof 2a. The walls of the elevator car 2 have been arranged to act as railings for the maintenance person.

The elevator arrangement also comprises a mechanical upper safety means to prevent the elevator car from colliding the ceiling 1d of the elevator shaft 1c when the inspection mode is witched on. The upper safety means is operatively connected to bi-directional safety brakes fastened to the elevator car 2.

It is obvious to the person skilled in the art that the invention is not restricted to the examples described above but that it may be varied within the scope of the claims presented below. Thus, for instance the roof of the elevator car and the mechanisms for opening and closing the roof can be different from what is presented above.

It is also obvious to the person skilled in the art that the suspension and/or traction ratio of the elevator car can be different from what is presented above. The suspension and/or traction ratio can be, for instance 1:1, the suspension ratio can also be 2:1 but the traction ratio 1:1. However, it is essential that the elevator structure is such that the roof of the elevator car can be easily opened.

It is further obvious to the person skilled in the art that the suspension and traction arrangement of the elevator car can be different from what is presented above. The location of the hoisting machinery can also be in the upper part of the elevator shaft, and the suspension and traction of the elevator car can be carried out in different ways, for instance with common hoisting ropes that suspend the elevator car and the balance weight and also move them.

It is still further obvious to the person skilled in the art that the electrical control mechanism in order to control the position of the roof of the elevator car can also be different from what is presented above.

1. Elevator arrangement comprising an elevator with an elevator control system, a safety system and an inspection or maintenance mode, which elevator having an elevator car arranged to run up and down in an elevator shaft along guide rails, and which elevator car is equipped with a roof, wherein the roof of the elevator car is arranged to uncover upper part of the elevator car to form a natural safe working space for conducting inspection and maintenance tasks from inside the elevator car to the elevator shaft and to form the refuge space inside the elevator car, and that the arrangement comprises a control mechanism in order to control the position of the roof.

2. Elevator arrangement according to claim 1, wherein the elevator arrangement comprises opening means that are enabled to open and close the roof only when the elevator is switched on to the inspection or maintenance mode.

3. Elevator arrangement according to claim 1, wherein the control mechanism comprises at least a trigger element and control switches activated by the movement of the trigger element and operatively connected at least to the elevator control system and to the elevator safety system.

4. Elevator arrangement according to claim 3, wherein the trigger element is arranged to move in connection with the movement of the roof of the elevator car, and to trigger the first control switch when the roof is in lowermost position, and to trigger the second control switch when the roof is in uppermost position.

5. Elevator arrangement according to claim 4, wherein when the first control switch is triggered the elevator is enabled to run in the normal mode of the elevator, and when second control switch is triggered the elevator is enabled to run in the inspection or maintenance mode of the elevator.

6. Elevator arrangement according to claim 5, wherein the trigger element is a disc type element with a convex outer edge and a concave recess in the periphery of the disc, and that the trigger element is arranged to rotate in connection with the movement of the roof of the elevator car.

7. Elevator arrangement according to claim 6, wherein the control mechanism is arranged so that when the roof of the elevator car is in its lowermost position the trigger of the first control switch is in the recess and the normal mode of the elevator is enabled, and that when the roof of the elevator car is in its uppermost position the trigger of the second control switch is in the recess and the inspection mode of the elevator is enabled.

8. Elevator arrangement according to claim 7, wherein the roof of the elevator car is supported by articulated arms with lower, middle and upper pivot points and the trigger element is fastened to the lower pivot point of at least one articulated arm at the lower end of said articulated arm in a way that the trigger element turns along the lower part of the articulated arm when the roof of the elevator car is opening or closing.

9. Elevator arrangement according to claim 1, wherein the control mechanism is arranged to control unwanted weight on the roof of the elevator car when the roof is in its lowermost position and in case of unwanted weight exists and the roof is pressed downwards the first control switch is arranged to send a signal to the elevator control system to prevent both the normal mode run and the inspection run.

10. Elevator arrangement according to claim 1, wherein the control mechanism with its trigger element and control switches is arranged to activate the safety gear of the elevator.

11. Elevator arrangement according to claim 1, wherein the control mechanism with its trigger element and control switches is arranged to the lighting during the inspection run.

12. Elevator arrangement according to claim 1, wherein the opening means are arranged to open and close the roof essentially in a vertical direction.

13. Elevator arrangement according to claim 1, wherein the roof comprises two essentially similar halves, that are hinged at the upper part of the elevator car essentially in the central area of the elevator car, and that the opening means are arranged to open and close the halves of the roof turning the halves around the hinges towards the center line of the elevator car when opening the halves and towards the front and back walls of the elevator car when closing the halves.

14. Elevator arrangement according to claim 1, wherein the roof comprises two essentially similar halves, that are hinged at the upper part of the elevator car close to the front and back wall of the elevator car, and that the opening means are arranged to open and close the halves of the roof turning the halves around the hinges towards front and back walls of the elevator car when opening the halves and towards the center line of the elevator car when closing the halves.

15. Elevator arrangement according to claim 1, wherein the height of the elevator shaft is equal to the total height of the floors of the building or less than the total height of the floors of the building 1.

16. Elevator comprising an elevator control system, a safety system and an inspection or maintenance mode, an elevator car arranged to run up and down in an elevator shaft along guide rails, the elevator car equipped with a roof, wherein the roof of the elevator car is arranged to move with respect to the elevator car between a close position and a distant position, in which distant position an access for conducting inspection and maintenance tasks from inside the elevator car to the elevator shaft is opened.

17. Elevator according to claim 16, wherein the elevator control system enables the elevator car to run up or down in the elevator shaft only if the roof of the elevator car is fully opened or fully closed.
